(19) United States
(12) Patent Application Publication
(10) Pub. No.: US 2019/0338150 A1
(43) Pub. Date: Nov. 7, 2019

(54) Surface Active Coating Composition

(71) Applicant: PPG Industries Ohio, Inc., Cleveland, OH (US)

(72) Inventors: Cynthia Kutchko, Pittsburgh, PA (US); Steven E. Bowles, Pittsburgh, PA (US); Peter A. Lukus, Sarver, PA (US); Wei Wang, Allison Park, PA (US)

(21) Appl. No.: 15/969,228

(22) Filed: May 2, 2018

(51) Int. Cl. C09D 5/16; C09D 183/08; C09D 7/63; F28F 19/04

(52) U.S. Cl. CPC C09D 5/1681; C09D 183/08; B01D 53/265; F28F 19/04; C09D 7/63

(57) ABSTRACT

A surface active coating composition includes: (i) a polymer prepared from a mixture of reactants including (a) at least one polysiloxane and (b) a metal alkoxide; and (ii) a hydrophilic and/or a hydrophobic additive. A substrate at least partially coated with the surface active coating composition is also disclosed. A method of condensing a polar fluid by contacting a substrate at least partially coated with the surface active coating composition with a polar fluid, such that the polar fluid condenses on at least a portion of the coated substrate is also disclosed.

### FIELD OF THE INVENTION

The present invention relates to a surface active coating composition, substrates coated with the surface active coating composition, and methods of condensing a polar fluid by contacting a substrate with the surface active coating composition.

### BACKGROUND OF THE INVENTION

Coating compositions applied on substrates and cured to form a coating are used in various industries to facilitate the condensation of water, or other polar fluids, on the coating from the surrounding air. Examples include coating compositions used on air wells or on heating, ventilation, and air conditioning (HVAC) systems (e.g., condenser tubes thereof). Rapid condensation of the water from the air in the area of these coatings allows for the substrate coated with the coating composition to operate more efficiently and more cost effectively. An improved coating composition that more efficiently condenses water from the surrounding air is therefore desirable.

### SUMMARY OF THE INVENTION

The present invention is directed to a surface active coating composition including: (i) a polymer prepared from a mixture of reactants including (a) at least one polysiloxane and (b) a metal alkoxide; and (ii) a hydrophilic and/or a hydrophobic additive.

The present invention is also directed to a substrate at least partially coated with a surface active coating composition, the coating composition including: (i) a polymer prepared from a mixture of reactants including (a) at least one polysiloxane and (b) a metal alkoxide; and (ii) a hydrophilic and/or a hydrophobic additive.

The present invention is also directed to a method of condensing a polar fluid including: contacting a substrate at least partially coated with a surface active coating composition with a polar fluid, such that the polar fluid condenses on at least a portion of the coated substrate. The coating composition includes: (i) a polymer prepared from a mixture of reactants including (a) at least one polysiloxane and (b) a metal alkoxide; and (ii) a hydrophilic and/or a hydrophobic additive.

### BRIEF DESCRIPTION OF THE DRAWINGS

FIG. 1 shows micrographs taken by a scanning electron microscope of a coating composition applied on a substrate after completion of a conical bend test, according to Example 3; and

FIG. 2 shows micrographs taken by a scanning electron microscope of a coating composition applied on a substrate after completion of a conical bend test, according to Example 4.

### DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “an” alkoxysilane, “a” metal alkoxide, and the like refer to one or more of these items. Also, as used herein, the term “polymer” is meant to refer to prepolymers, oligomers, and both homopolymers and copolymers. The term “resin” is used interchangeably with “polymer.”

As used herein, the transitional term “comprising” (and other comparable terms, e.g., “containing” and “including”) is “open-ended” and is used in reference to compositions, methods, and respective component(s) thereof that are essential to the invention, yet open to the inclusion of unspecified matter.

The present invention may directed to a surface active coating composition including (i) a polymer prepared from a mixture of reactants including (a) at least one polysiloxane and (b) a metal alkoxide; and (ii) a hydrophilic and/or a hydrophobic additive. A surface active coating composition may refer to a coating composition that condenses water (or other polar fluid) from the surroundings and onto a substrate when the coating composition is applied to a substrate and cured. A surface active coating composition, when applied to the substrate and cured, may contribute to the coated substrate exhibiting other advantageous properties, such as easy-to-clean, self-cleaning, anti-fouling, and/or anti-fogging (e.g., promoting condensation of water in the form of a film rather than in the form of small droplets) properties.

Polymer component (i) may be prepared from a reaction of at least one polysiloxane. The at least one polysiloxane may include a single polysiloxane or a mixture of polysiloxanes. The at least one polysiloxane may include polysiloxanes having the general structure of Formula I below:

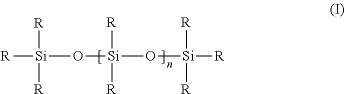

In Formula I, n may range from 1 to 100, and each R independently represents a group selected from hydrogen, a hydroxyl group, a monovalent hydrocarbon group (optionally fluorinated), and mixtures thereof. Each R group may be identical or different. The at least one polysiloxane may include a fluorinated polysiloxane. Non-limiting examples of fluorinated polysiloxanes include polytrifluoropropylmethylsiloxane. The at least one polysiloxane may be silanol terminated.

In one non-limiting examples, the polymer component (i) may include at least two polysiloxanes, a first polysiloxane and a second polysiloxane, which are different from one another. The first polysiloxane may include a polysiloxane having the general structure of Formula I, while the second polysiloxane may include a fluorinated polysiloxane. For example, the polysiloxane of Formula I may be a silanol terminated polydimethylsiloxane and the fluorinated polysiloxane may be a polytrifluoropropylmethylsiloxane. However, it will be appreciated that additional and/or alternative combinations of polysiloxanes may be included. The at least one of the polysiloxanes may be present in the coating composition in an amount of 5-80 weight percent, 10-75 weight percent, 20-75 weight percent, 30-75 weight percent, 40-75 weight percent, 50-80 weight percent, or 50-75 weight percent, based on total solids weight of the coating composition. The at least one polysiloxane may impart hydrophobicity (by virtue of a hydrophobic portion present in the polymer) to a cured coating prepared including the at least one polysiloxane in the coating composition. The hydrophobic portion is defined as portion of the coating composition that exhibits a water contact angle (WCA) of at least 90° using the Kruss Drop Shape Analysis.

Polymer component (i) may also include at least one metal alkoxide. By “alkoxide” it is meant the conjugate base of an alcohol (Y—OH) where Y may be a C₁-C₁₀ linear or branched alkyl group. The metal alkoxide may include a polyvalent metal. Examples of suitable metal alkoxides include zirconium alkoxide (such as zirconium butoxide or zirconium methoxide), titanium alkoxide, tantalum alkoxide, hafnium alkoxide, aluminum alkoxide, zirconium isoproproxide isopropanol, or mixtures thereof. The metal alkoxide may be present in the coating composition in an amount of at least 0.5 weight percent, at least 1 weight percent, or at least 2 weight percent, based on total solids weight of the coating composition. The metal alkoxide may be present in the coating composition in an amount of less than 20 weight percent, less than 15 weight percent, less than 10 weight percent, or less than 5 weight percent, based on solids weight of the coating composition. The metal alkoxide may be present in the coating composition in an amount of 0.5-20 weight percent, such as, 0.5-5 weight percent, 0.5-10 weight percent, 0.5-15 weight percent, 1-20 weight percent, 1-10 weight percent, 1-5 weight percent, 2-20 weight percent, 2-10 weight percent, or 2-5 weight percent, based on solids weight of the coating composition.

The additive may be a hydrophilic additive, which may not be a reactant that forms the polymer component (i). The hydrophilic additive may be added after polymer component (i), as previously-described, is prepared. The hydrophilic additive may impart hydrophilicity (create a hydrophilic portion) to a cured coating prepared including the hydrophilic additive in the coating composition. The hydrophilic portion is defined as a portion of the coating composition that exhibits a WCA of less than 90° using the Kruss Drop Shape Analysis. Non-limiting examples of hydrophilic additives include nano-sized particles of titanium dioxide (TiO₂), aminopropylsilane treated silica, untreated silica, and/or mixtures thereof. By “nano-sized” it is meant that the particles of TiO₂ have an average particle size of no more than 100 nanometers, according to ASTM F1877-16.

The hydrophilic additive may be present in the coating composition in an amount of at least 10 weight percent, at least 15 weight percent, at least 20 weight percent, or at least 25 weight percent, based on total solids weight of the coating composition. The hydrophilic additive may be present in the coating composition in an amount less than 50 weight percent, less than 40 weight percent, or less than 35 weight percent based on total solids weight of the coating composition. The hydrophilic additive may be present in the coating composition in an amount of 10-50 weight percent, 15-40 weight percent, 20-35 weight percent, or 25-35 weight percent, based on total solids weight of the coating composition. An effective amount of the hydrophilic additive may be added to the coating composition such that, when applied to the substrate and cured, the overall coating is hydrophobic. An effective amount of the hydrophilic additive may be added to the coating composition such that, when applied to the substrate and cured, the overall cured coating exhibits a WCA of at least 100°, at least 110°, at least 120°, at least 130°, at least 140°, or at least 150°. An effective amount of the hydrophilic additive may be added to the coating composition such that, when applied to the substrate and cured, the overall coating is superhydrophobic. As used herein, the term “overall coating” refers to the coating when considered as a whole, as opposed to the characteristics of any one portion of the coating. Superhydrophobic is defined as the overall coating demonstrating a WCA of at least 150° using the Kruss Drop Shape Analysis. An effective amount of the hydrophilic additive may be added to the coating composition such that, when applied to the substrate and cured, the overall cured coating exhibits a WCA of at least 150° and a hysteresis of no more than 10° or no more than 5°. As used herein, hysteresis is defined as a difference of the advancing contact angle and the receding contact angle of a drop of liquid (such as water) on a plane angled between 0° and 90° relative to the horizontal. Hysteresis may be measured using the Kruss Drop Shape Analyzer (DSA 100) according to ASTM test method D7334.

The additive may be a hydrophobic additive, which may not be a reactant that forms the polymer component (i). The hydrophobic additive may be added after polymer component (i), as previously-described, is prepared. The hydrophobic additive may impart hydrophobicity (create a hydrophobic portion) to a cured coating prepared including the hydrophobic additive in the coating composition. The hydrophobic portion is defined as a portion of the coating composition that exhibits a WCA of at least 90° using the Kruss Drop Shape Analysis. Non-limiting examples of hydrophobic additives include a fluorinated treated silica, a fluorinated silane treated silica, a hydrophobic treated clay, a hydrophobic treated metal oxide, a rare earth metal oxide, or mixtures thereof.

The hydrophobic additive may be present in the coating composition in an amount of at least 3 weight percent, at least 5 weight percent, at least 10 weight percent, or at least 15 weight percent based on total solids weight of the coating composition. The hydrophobic additive may be present in the coating composition in an amount less than 30 weight percent, less than 25 weight percent, less than 20 weight percent, or less than 18 weight percent based on total solids weight of the coating composition. The hydrophobic additive may be present in the coating composition in an amount of 3-30 weight percent, 5-25 weight percent, 10-20 weight percent, or 15-20 weight percent, based on total solids weight of the coating composition. An effective amount of the hydrophobic additive may be added to the coating composition such that, when applied to the substrate and cured, the overall coating is hydrophobic. An effective amount of the hydrophobic additive may be added to the coating composition such that, when applied to the substrate and cured, the overall cured coating exhibits a WCA of at least 100°, at least 110°, at least 120°, at least 130°, at least 140°, or at least 150°. An effective amount of the hydrophobic additive may be added to the coating composition such that, when applied to the substrate and cured, the overall cured coating is superhydrophobic. An effective amount of the hydrophobic additive may be added to the coating composition such that, when applied to the substrate and cured, the overall cured coating exhibits a WCA of at least 150° and a hysteresis of no more than 10° or no more than 5°.

The coating composition may further include a coupling agent. The coupling agent may include functional groups such as hydroxyl groups, methoxide groups, or ethoxide groups that are reactive with a substrate such as aluminum to provide or enhance adhesion between the coating composition and the substrate. The coupling agent may include a silane, an alkoxysilane, a fluoroalkylsilane, an aminopropyltriethoxysilane, and/or mixtures thereof. The coupling agent may be an alkoxysilane, such as 3-aminopropyltriethoxysilane. Other coupling agents may be included in the coating composition based on the composition of the substrate and/or the other components included in the coating composition.

The coating composition may further include a cross-linking agent. The cross-linking agent may be any cross-linking agent capable of reacting with free hydroxyl groups in the coating composition to cross-link the coating composition. Non-limiting examples of cross-linking agents include phenolic resins, amino resins, epoxy resins, beta-hydroxy(alkyl) amide resins, alkylated carbamate resins, isocyanates, polyacids, anhydrides, organometallic acid-functional materials, polyamines (e.g., melamine), polyamides, aminoplasts, multifunctional silanes (e.g., tetraethoxy orthosilicate), and mixtures thereof.

Any of the coating compositions described herein may include additional materials. Non-limiting examples of additional materials that can be used with the coating compositions of the present invention include: colorants (e.g., pigments and/or dyes), plasticizers, abrasion resistant particles, corrosion resistant particles, corrosion inhibiting additives, fillers including, but not limited to, clays, inorganic minerals, anti-oxidants, hindered amine light stabilizers, UV light absorbers and stabilizers, surfactants, flow and surface control agents, thixotropic agents, organic co-solvents, reactive diluents, catalysts, reaction inhibitors, and other customary auxiliaries.

After preparing the coating composition, the coating composition may be applied to a substrate and cured to form a coating. The substrate may be any suitable material. For example, the substrate may be metallic or non-metallic. Metallic substrates may include, but are not limited to, tin, steel (including stainless steel, electrogalvanized steel, cold rolled steel, and hot-dipped galvanized steel, among others), aluminum, aluminum alloys, zinc-aluminum alloys, steel coated with a zinc-aluminum alloy, or aluminum plated steel. The metallic substrates may also further include a metal pretreatment coating or conversion coating. Examples of suitable pretreatment coatings or conversion coatings include, but are not limited to, zinc phosphate, iron, phosphate, or chromate-containing pretreatments. Other examples of suitable pretreatment coatings or conversion coatings include, but are not limited to, thin-film pretreatment coatings such as a zirconium or titanium-containing pretreatment. The metal pretreatment coating may also include a sealer, such as a chromate or non-chromate sealer.

Non-metallic substrates may comprise polymeric materials. Suitable polymeric materials for the substrate may include plastic, polyester, polyolefin, polyamide, cellulosic, polystyrene, polyacrylic, poly(ethylene naphthalate), polypropylene, polyethylene, nylon, EVOH, polylactic acid, other “green” polymeric substrates, poly(ethyleneterephthalate) (PET), polycarbonate, polycarbonate acrylonitrile butadiene styrene (PC/ABS), or polyamide. Other non-metallic substrates may include glass, wood, wood veneer, wood composite, particle board, medium density fiberboard, cement, stone, paper, cardboard, textiles, leather, both synthetic and natural, and the like. Non-metallic substrates may also include a treatment coating that is applied before application of the coating, which increases the adhesion of the coating to the substrate.

The substrate may be a portion of a HVAC system comprising metal, such as aluminum, an aluminum alloy, or stainless steel. The substrate may be a surface of condenser tubes of the HVAC system, such that the condenser tubes are coated with the coating composition, and the coated condenser tubes may condense water onto the surface thereof. Alternatively, the substrate may be glass, such that the glass coated by the coating composition renders the glass self-cleaning or easy-to-clean.

Application of the coating composition to the substrate may render the substrate surface active. In one example, applying the coating composition to the substrate, such as a metal substrate, provides a coated surface of the substrate that is capable of condensing polar fluid (e.g., water) from the surrounding air onto the surface of the coated substrate. In another example, applying the coating composition to the substrate, such as glass, provides a coated glass surface that is easy-to-clean or self-cleaning.

The coating compositions described herein may be applied by any means known in the art, such as electrocoating, spraying, electrostatic spraying, dipping, rolling, brushing, and the like. The coating composition may be applied to a substrate by spraying using a syphon-feed spray gun. The coating composition may be spray applied to the substrate at a number of different thicknesses (e.g., using different numbers of passes).

The coating composition, when applied to the substrate and cured to form a coating, may render the coated substrate hydrophobic. The coating composition, when applied to the substrate and cured to form a coating, may render the coated substrate hydrophobic, so as to exhibit a WCA of at least 140°. The coating composition, when applied to the substrate and cured to form a coating, may render the coated substrate superhydrophobic. The coating composition, when applied to the substrate and cured to form a coating, may render the coated substrate superhydrophobic, such that it exhibits a WCA of at least 150° and a hysteresis of no more than 10°.

When the coating composition is applied to the substrate and cured to form a coating, the cured coating may include at least one hydrophobic portion including the at least one polysiloxane and at least one hydrophilic portion including the hydrophilic additive. The hydrophobic portion may exhibit a WCA of at least 90°, while the hydrophilic portion may exhibit a WCA of less than 90°. It will be appreciated that, while the cured coating may include at least one hydrophobic portion and at least one hydrophilic portion, the overall coating may be hydrophobic, such that the overall cured coating exhibits a WCA that is hydrophobic.

The surface active coating composition, when applied to a substrate and cured to form a coating, may include a plurality of hydrophobic portions and a plurality of hydrophilic portions. The coating composition may include alternating hydrophobic and hydrophilic portions. Alternating hydrophobic and hydrophilic portions may mean that at least one of the hydrophobic portions positioned between at least two of the hydrophilic portions not in direct contact with one another and/or at least one of the hydrophilic portions positioned between at least two of the hydrophobic portions not in direct contact with one another. It will be appreciated that, while the cured coating may include alternating hydrophobic and hydrophilic portions, the overall coating may be hydrophobic, such that the overall cured coating exhibits a WCA that is hydrophobic.

The following examples are presented to exhibit the general principles of the invention. The invention should not be considered as limited to the specific examples presented. All parts and percentages in the examples are by weight unless otherwise indicated.

### Example 1

### Water Contact Angle for Coating Composition without Metal Alkoxide

A coating composition was prepared from the components listed in Table 1.

TABLE 1

| | | Weight |
|---|---|---|
| | | Percent |
| | Total | (on |
| Component | Grams | solids) |
| DMS-S35 silanol terminated polydimethylsiloxane¹ | 14.49 | 34.48 |
| FMS-9922 polytrifluoropropylmethylsiloxane | 8.69 | 20.68 |
| silanol terminated² | | |
| Nano TiO₂—P25, Aeroxide (mixed anatase/rutile | 13.04 | 31.02 |
| crystal structure)³ | | |
| 3-Aminopropyltriethoxysilane⁴ | 5.80 | 13.80 |
| n-Butyl acetate⁵ | 57.96 | — |
| Dibutyltin diacetate⁶ | 0.01 | 0.02 |

A total of 14.49 grams of DMS-S35 silanol terminated polydimethylsiloxane, 8.69 grams of FMS-9922 polytrifluoropropylmethylsiloxane silanol terminated, and 57.96 grams of n-butyl acetate were added to a suitable reaction vessel equipped with an air motor containing a cowles dispersing blade first set at a 125 rpm. Nano-sized particles of TiO₂—P25 aeroxide (13.04 grams) (from Evonik Industries (Essen, Germany) and having a mean particle side which is 25 nm) was slowly added to the reaction vessel over a time of 15 minutes. The speed on the air motor was increased to 1600 rpm and dispersed for 30 minutes. The speed of the air motor was set to 125 rpm after the 30 minutes and 5.8 grams of 3-aminopropyltriethoxysilane was dripped using a pipet into the mixture over 10 minutes. Dibutyltin diacetate (0.01 gram) was added and allowed to stir for an additional 10 minutes at 125 rpm. This mixture was then spray-applied to pre-treated (using X-Bond 4000 from PPG Industries, Inc. (Pittsburgh, Pa.)) aluminum panels and baked at 120° C. for 2 hours. The panels were removed from the oven and cooled. The coating thickness was approximately 0.3 mm. The panels were tested the next day for WCA and hysteresis using the Kruss Drop Shape Analysis using the Kruss Drop Shape Analyzer (DSA 100) according to ASTM test method D7334. The WCA for this coating was 137.1°. The hysteresis demonstrated by the coating was 4°. ¹ Mw of approximately 49,000. Available from Gelest, Inc. (Morrisville, Pa.)² Available from Gelest, Inc. (Morrisville, Pa.)³ Particle size of 21 nm. Available from Evonik Industries (Essen, Germany)⁴ Available from Gelest, Inc. (Morrisville, Pa.)⁵ Available from Fisher Scientific (Hampton, N.H.)⁶ Available from Sigma Aldrich (St. Louis, Mo.)

### Example 2

### Water Contact Angle for Coating Composition Including Metal Alkoxide and a Hydrophilic Additive

A coating compositions was prepared from the components listed in Table 2.

TABLE 2

| | | Weight |
|---|---|---|
| | | Percent |
| | Total | (on |
| Component | Grams | solids) |
| DMS-S35 Silanol Terminated polydimethylsiloxane¹ | 14.00 | 33.22 |
| FMS-9922 Polytrifluoropropylmethylsiloxane | 8.40 | 19.93 |
| silanol terminated² | | |
| Nano TiO₂—P25, Aeroxide (mixed anatase/rutile | 12.60 | 29.90 |
| crystal structure)³ | | |
| Zirconium butoxide⁷ | 1.40 | 3.32 |
| 3-Aminopropyltriethoxysilane⁴ | 5.60 | 13.30 |
| n-Butyl acetate⁵ | 58.00 | — |
| Dibutyltin diacetate⁶ | 0.14 | 0.33 |

A total of 14.00 grams of DMS-S35 silanol terminated polydimethylsiloxane, 8.40 grams of FMS-9922 polytrifluoropropylmethylsiloxane silanol terminated, 1.40 grams of zirconium butoxide, and 58.00 grams of n-butyl acetate were added to a suitable reaction vessel equipped with an air motor containing a cowles dispersing blade first set at a 125 rpm. Then, 12.60 grams of nano-sized TiO₂—P25 aeroxide particles was slowly added to the reaction vessel over a time of 15 minutes, and the speed on the air motor was increased to 1600 rpm and dispersed for 30 minutes. The speed of the air motor was set to 125 rpm after the 30 minutes, and 5.6 grams of 3-aminopropyltriethoxysilane was dripped using a pipet into the mixture over 10 minutes. Dibutyltin diacetate (0.01 gram) was added and allowed to stir for an additional 10 minutes at 125 rpm. This mixture was then spray applied to pre-treated (using X-Bond 4000 from PPG Industries, Inc. (Pittsburgh, Pa.)) aluminum panels at two thickness, thin (2 spray passes having a thickness of approximately 0.1 mm) and thick (4 spray passes having a thickness of approximately 0.3 mm), and baked at 120° C. for 2 hours. The panels were removed from the oven and cooled. The panels were tested the next day for WCA and hysteresis using the Kruss Drop Shape Analysis using the Kruss Drop Shape Analyzer (DSA 100) according to ASTM test method D7334. The WCA for this coating was 152.5°. There were differences in the hysteresis based on the different thicknesses of the coating on the panel as shown in Table 3 below. ⁷ Available from Sigma Aldrich (St. Louis, Mo.)

TABLE 3

| | | Receding | Advancing | | Drop |
|---|---|---|---|---|---|
| Coating | Table | Contact | Contact | Hysteresis | Volume |
| Thickness | Angle | Angle (θ_{R}) | Angle (θ_{A}) | (θ_{A}-θ_{R}) | (μl) |
| Thin (2 passes) | 0.5° | 147.2° | 150.8° | 3.6° | 30 |
| Thick (4 | 19.6° | 50° | 148.8° | 98.8° | 30 |
| passes) | | | | | |

### Example 3

### SEM Results for Coating Composition without Metal Alkoxide

A sol-gel based coating composition was formulated from the components listed in Table 4 and left to sit overnight in closed amber bottles. The coating composition was applied the following day with a syphon-feed gun and cured at 120° C. for 2 hours. The coating composition was sprayed on a pretreated aluminum 2024 panel.

TABLE 4

| | | Weight |
|---|---|---|
| | Total | Percent |
| Component | Grams | (on solids) |
| DMS-S35 silanol terminated | 10.83 g | 44.77 |
| polydimethylsiloxane¹ | | |
| FMS-9922 Polytrifluoropropylmethylsiloxane | 6.50 g | 26.87 |
| silanol terminated² | | |
| Tetraethoxy silane⁸ | 2.41 g | 9.96 |
| 3-Aminopropyltriethoxysilane⁴ | 4.33 g | 17.90 |
| n-Butyl acetate⁵ | 55.05 g | — |
| Zirconium butoxide⁷ | 0 g | 0 |
| Dibutyltin diacetate⁶ | 0.12 g | 0.50 |

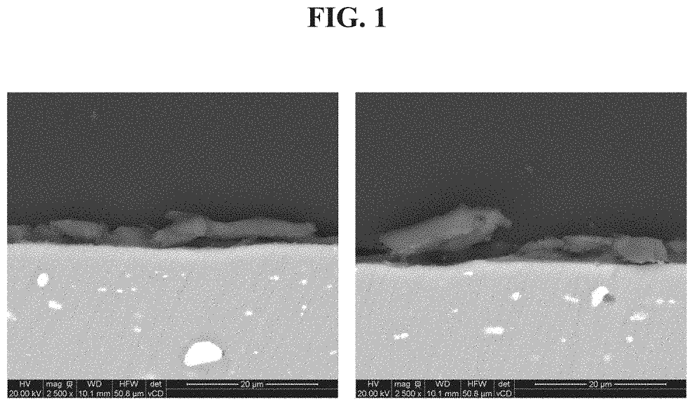

A conical bend test was completed on the panel, and a scanning electron microscope (SEM) was used to view the coated panel after the conical bend test. The conical bend test was performed according to ASTM test method D522/D522M-13 using a BYK-Gardner Conical Mandrel from Paul N. Gardner Company, Inc. (Pompano Beach, Fla.). FIG. 1 shows the resulting SEM micrographs. ⁸ Available from Sigma Aldrich (St. Louis, Mo.)

### Example 4

### SEM Results for Coating Composition with Metal Alkoxide

A sol-gel based coating composition was formulated from the components listed in Table 5 and left to sit overnight in closed amber bottles. The coating composition was applied the following day with a syphon-feed gun and cured at 120° C. for 2 hours. The coating composition was sprayed on a pretreated aluminum 2024 panel.

TABLE 5

| | | Weight |
|---|---|---|
| | Total | Percent |
| Component | Grams | (on solids) |
| DMS-S35 silanol terminated | 10.83 g | 43.86 |
| polydimethylsiloxane¹ | | |
| FMS-9922 Polytrifluoropropylmethylsiloxane | 6.50 g | 26.32 |
| silanol terminated² | | |
| Tetraethoxy silane⁸ | 2.41 g | 9.76 |
| 3-Aminopropyltriethoxysilane⁴ | 4.33 g | 17.53 |
| n-Butyl acetate⁵ | 55.05 g | — |
| Zirconium butoxide⁷ | 0.5 g | 2.04 |
| Dibutyltin diacetate⁶ | 0.12 g | 0.49 |

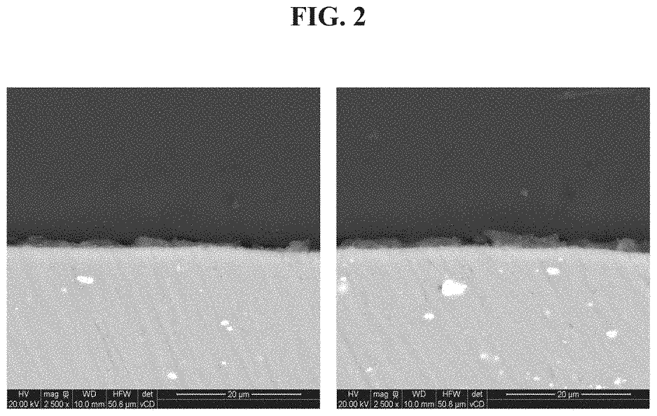

A conical bend test was completed on the panel, and a SEM was used to view the coated panel after the conical bend test. FIG. 2 shows the resulting SEM micrographs. The conical bend test was performed according to ASTM test method D522/D522M-13 using a BYK-Gardner Conical Mandrel from Paul N. Gardner Company, Inc. (Pompano Beach, Fla.).

The coating on the panel containing metal alkoxide (Example 4, FIG. 2) showed improved coating uniformity over the coating not containing a metal alkoxide (Example 3, FIG. 1). Further, based on the micrographs, the adhesion of the coating including a metal alkoxide (Example 4, FIG. 2) in the coating composition had a better adhesion to the substrate compared to the coating without the metal alkoxide (Example 3, FIG. 1). The inclusion of the metal alkoxide in the coating composition (Example 4, FIG. 2) imparted enhanced flexibility to the coating compared to the same coating composition prepared without the metal alkoxide (Example 3, FIG. 1), based on the performed conical bend test and SEM analyzed panels.

### Example 5

### Water Contact Angle for Coating Composition Including Metal Alkoxide and a Hydrophobic Additive

A coating composition was prepared from the components listed in Table 6. The mixture was a sol gel coating composition.

TABLE 6

| | | Weight |
|---|---|---|
| | Total | Percent |
| Component | Grams | (on solids) |
| DMS-S35 silanol terminated polydimethylsiloxane¹ | 9.63 g | 35.67 |
| FMS-9922 Polytrifluoropropylmethylsiloxane | 5.78 g | 21.41 |
| silanol terminated² | | |
| Tetraethoxy silane⁸ | 2.14 g | 7.93 |
| Trifluoropropyl methoxysilane modified silica⁹ | 4.815 g | 17.84 |
| 3-Aminopropyltriethoxy silane⁴ | 3.85 g | 14.26 |
| n-Butyl acetate⁵ | 68.19 g | — |
| Dibutyltin diacetate⁶ | 0.11 g | 0.41 |
| Zirconium butoxide⁷ | 0.67 g | 2.48 |

⁹5% surface modification by surface silanols, available from PPG Industries, Inc. (Pittsburgh, Pennsylvania)

The components were all mixed and allowed to sit for 24 hours. The coating composition was then sprayed onto pretreated aluminum using an HVLP spray gun. The panel was then placed in the oven at 120° C. for 2 hours to cure. The coating thickness was approximately 0.4 mm. WCA and hysteresis were measured using a Kruss DSA 100 Drop Shape Analyzer according to ASTM test method D7334. The panels were tested for WCA and hysteresis. The average WCA value was 140°, and the average hysteresis was 5.4°.

The present invention further includes the subject matter of the following clauses.

Clause 1: A surface active coating composition comprising: (i) a polymer prepared from a mixture of reactants comprising (a) at least one polysiloxane and (b) a metal alkoxide; and (ii) a hydrophilic and/or a hydrophobic additive.

Clause 2: The surface active coating composition of clause 1, wherein the at least one polysiloxane comprises a first polysiloxane and a second polysiloxane different from the first polysiloxane, wherein the second polysiloxane comprises a fluorinated polysiloxane.

Clause 3: The surface active coating composition of clause 2, wherein the first polysiloxane and/or the second polysiloxane are silanol terminated.

Clause 4: The surface active coating composition of clause 2 or 3, wherein the first polysiloxane comprises a polysiloxane having the general structure:

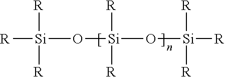

wherein n ranges from 1 to 100, and each R, which may be identical or different, represents a group selected from hydrogen, a hydroxyl group, a monovalent hydrocarbon group, and mixtures of any of the foregoing.

Clause 5: The surface active coating composition of any of clauses 2-4, wherein the second polysiloxane comprises polytrifluoropropylmethylsiloxane.

Clause 6: The surface active coating composition of any of the preceding clauses, further comprising a coupling agent.

Clause 7: The surface active coating composition of clause 6, wherein the coupling agent comprises a silane, an alkoxysilane, a fluoroalkylsilane, an aminopropyltriethoxysilane, or mixtures thereof.

Clause 8: The surface active coating composition of any of the preceding clauses, wherein the hydrophilic additive comprises at least 10 weight percent of the coating composition based on total solids weight of the coating composition.

Clause 9: The surface active coating composition of any of the preceding clauses, wherein the metal alkoxide comprises zirconium alkoxide, titanium alkoxide, tantalum alkoxide, hafnium alkoxide, aluminum alkoxide, zirconium isoproproxide isopropanol, or mixtures thereof.

Clause 10: The surface active coating composition of any of the preceding clauses, wherein the metal alkoxide comprises at least 0.5 weight percent of the coating composition based on total solids weight of the coating composition.

Clause 11: The surface active coating composition of any of the preceding clauses, wherein, when applied to a substrate and cured to form a coating, the coating is hydrophobic.

Clause 12: The surface active coating composition of any of the preceding clauses, wherein when applied to a substrate and cured to form a coating, the coated substrate exhibits a water contact angle of at least 140°.

Clause 13: The surface active coating composition of any of the preceding clauses, wherein when applied to a substrate and cured to form a coating, the coating comprises at least one hydrophobic portion comprising the at least one polysiloxane and at least one hydrophilic portion comprising the additive (ii).

Clause 14: The surface active coating composition of clause 13, wherein, when applied to a substrate and cured to form a coating, the coating comprises a plurality of hydrophobic portions and a plurality of hydrophilic portions.

Clause 15: The surface active coating composition of any of the preceding clauses, wherein the hydrophilic additive comprises nano-sized particles comprising titanium dioxide, aminopropylsilane treated silica particles, untreated silica particles, or mixtures thereof.

Clause 16: The surface active coating composition of any of the preceding clauses, wherein, when applied to a substrate and cured to form a coating, the coated substrate exhibits a water contact angle of at least 150° and a hysteresis of no more than 10°.

Clause 17: The surface active coating composition of any of clauses 11-16, wherein, when applied to a substrate and cured to form a coating, the coating is superhydrophobic.

Clause 18: The surface active coating composition of any of clauses 1-17, further comprising a cross-linking agent.

Clause 19: The surface active coating composition of clause 18, wherein the cross-linking agent comprises a melamine.

Clause 20: The surface active coating composition of any of clauses 7-19, wherein the alkoxysilane comprises 3-aminopropyltriethoxysilane.

Clause 21: The surface active coating composition of any of clauses 1-20, wherein the metal alkoxide comprises 0.5-10 weight percent of the coating composition based on total solids weight of the coating composition.

Clause 22: The surface active coating composition of clause 21, wherein the metal alkoxide comprises 0.5-5 weight percent of the coating composition based on total solids weight of the coating composition.

Clause 23: The surface active coating composition of any of clauses 1-22, wherein the coating composition comprises an effective amount of the hydrophilic additive such that, when applied to a substrate and cured to form a coating, the coated substrate exhibits a water contact angle of at least 150° and a hysteresis of no more than 10°.

Clause 24: The surface active coating composition of any of clauses 2-23, wherein the first polysiloxane comprises polydimethylsiloxane.

Clause 25: The surface active coating composition of any of clauses 1-24, wherein the hydrophobic additive comprises at least 3 weight percent of the coating composition based on total solids weight of the coating composition.

Clause 26: The surface active coating composition of any of clauses 1-25, wherein the hydrophobic additive comprises a fluorinated treated silica, a fluorinated silane treated silica, a hydrophobic treated clay, a hydrophobic treated metal oxide, a rare earth metal oxide, or mixtures thereof.

Clause 27: The surface active coating composition of any of clauses 1-26, wherein the metal alkoxide comprises a polyvalent metal.

Clause 28: A substrate at least partially coated with the surface active coating composition of any of clauses 1-27.

Clause 29: The substrate of clause 28, wherein the substrate comprises metal or glass.

Clause 30: The substrate of clause 28 or 29, wherein the substrate comprises a surface of a condenser tube in a HVAC system.

Clause 31: The substrate of any of clauses 28-30, wherein the substrate comprises aluminum or stainless steel.

Clause 32: A method of condensing a polar fluid comprising: contacting a substrate at least partially coated with the surface active coating composition of any of clauses 1-26 with a polar fluid, such that the polar fluid condenses on at least a portion of the coated substrate.

Clause 33: The method of clause 32, wherein the polar fluid comprises water.

Whereas particular embodiments of this invention have been described above for purposes of illustration, it will be evident to those skilled in the art that numerous variations of the details of the present invention may be made without departing from the invention as defined in the appended claims.

The invention claimed is:

1. A surface active coating composition comprising:
(i) a polymer prepared from a mixture of reactants comprising (a) at least one polysiloxane and (b) a metal alkoxide; and
(ii) a hydrophilic and/or a hydrophobic additive.

2. The surface active coating composition of claim 1, wherein the at least one polysiloxane comprises a first polysiloxane and a second polysiloxane different from the first polysiloxane, wherein the second polysiloxane comprises a fluorinated polysiloxane.

3. The surface active coating composition of claim 2, wherein the first polysiloxane and/or the second polysiloxane are silanol terminated.

4. The surface active coating composition of claim 2, wherein the first polysiloxane comprises a polysiloxane having the general structure: 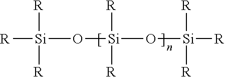
wherein n ranges from 1 to 100, and each R, which may be identical or different, represents a group selected from hydrogen, a hydroxyl group, a monovalent hydrocarbon group, and mixtures of any of the foregoing.

5. The surface active coating composition of claim 2, wherein the second polysiloxane comprises polytrifluoropropylmethylsiloxane.

6. The surface active coating composition of claim 1, further comprising a coupling agent.

7. The surface active coating composition of claim 6, wherein the coupling agent comprises a silane, an alkoxysilane, a fluoroalkylsilane, an aminopropyltriethoxysilane, or mixtures thereof.

8. The surface active coating composition of claim 1, wherein the hydrophilic additive comprises at least 10 weight percent of the coating composition based on total solids weight of the coating composition.

9. The surface active coating composition of claim 1, wherein the metal alkoxide comprises zirconium alkoxide, titanium alkoxide, tantalum alkoxide, hafnium alkoxide, aluminum alkoxide, zirconium isoproproxide isopropanol, or mixtures thereof.

10. The surface active coating composition of claim 1, wherein the metal alkoxide comprises at least 0.5 weight percent of the coating composition based on total solids weight of the coating composition.

11. The surface active coating composition of claim 1, wherein, when applied to a substrate and cured to form a coating, the coating is hydrophobic.

12. The surface active coating composition of claim 1, wherein, when applied to a substrate and cured to form a coating, the coated substrate exhibits a water contact angle of at least 140°.

13. The surface active coating composition of claim 1, wherein, when applied to a substrate and cured to form a coating, the coating comprises at least one hydrophobic portion comprising the at least one polysiloxane and at least one hydrophilic portion comprising the additive (ii).

14. The surface active coating composition of claim 13, wherein, when applied to a substrate and cured to form a coating, the coating comprises a plurality of hydrophobic portions and a plurality of hydrophilic portions.

15. The surface active coating composition of claim 1, wherein the hydrophilic additive comprises nano-sized particles comprising titanium dioxide, aminopropylsilane treated silica particles, untreated silica particles, or mixtures thereof.

16. The surface active coating composition of claim 1, wherein the hydrophobic additive comprises a fluorinated treated silica, a fluorinated silane treated silica, a hydrophobic treated clay, a hydrophobic treated metal oxide, a rare earth metal oxide, or mixtures thereof.

17. The surface active coating composition of claim 1, wherein the metal alkoxide comprises a polyvalent metal.

18. A substrate at least partially coated with the surface active coating composition of claim 1.

19. The substrate of claim 18, wherein the substrate comprises metal or glass.

20. The substrate of claim 18, wherein the substrate comprises a surface of a condenser tube in a HVAC system.

21. A method of condensing a polar fluid comprising:
contacting a substrate at least partially coated with the surface active coating composition of claim 1 with a polar fluid, such that the polar fluid condenses on at least a portion of the coated substrate.
